(19) United States
(12) Patent Application Publication
(10) Pub. No.: US 2007/0017928 A1
(43) Pub. Date: Jan. 25, 2007

(54) Method of retrofitting a vending machine

(76) Inventor: Richard G. Coppola, Richmond Heights, MO (US)

Correspondence Address: POLSTER, LIEDER, WOODRUFF & LUCCHESI, 12412 POWERSCOURT DRIVE SUITE 200, ST. LOUIS, MO, 63131-3615, US

(21) Appl. No.: 11/489,760

(22) Filed: Jul. 20, 2006

Related U.S. Application Data
(63) Continuation of application No. 11/421,935, filed on Jun. 2, 2006.
(60) Provisional application No. 60/700,991, filed on Jul. 20, 2005.
(60) Provisional application No. 60/777,160, filed on Feb. 27, 2006.
(60) Provisional application No. 60/701,269, filed on Jul. 21, 2005.

(51) Int. Cl. G07F 11/00

(52) U.S. Cl. 221/75

(57) ABSTRACT

A method of retrofitting an existing vending machine having products stacked vertically in a horizontal orientation in a number of storage locations and utilizing an electro-mechanical device for dispensing said products horizontally via a delivery channel to a delivery port, comprising: a) replacing said number of selectable storage locations having vertically stacked and horizontally oriented product with a plurality of product shelves each having a plurality of product storage locations having horizontal columns of vertically stored products; b) replacing said existing electromechanical device for dispensing said vertically stacked and horizontally oriented product with a product dispensing system that retrieves product from the horizontal columns of vertically oriented product in response to a customer selection; and, c) providing a channel that will convert the vertically oriented product delivered by the dispensing system that converts the vertically oriented product to a horizontally oriented position for delivery through a horizontally oriented customer product delivery port.

### RELATED APPLICATIONS

The present application claims priority to U.S. Provisional Patent Application No. 60/700,991, the contents of which is incorporated herein by reference, and is a continuation of U.S. patent application Ser. No. 11/421,935, the contents of which are expressly incorporated herein by reference. The present application is related to U.S. Provisional Patent Application Nos. 60/777,160 and 60/701,269, the contents of which are expressly incorporated herein by reference.

### BACKGROUND OF THE INVENTION

There are many existing vending machines that are capable of storing large quantities product but have relatively few different choices of product. For example, the machine may hold only five or six options for vending. Typically, these machines will also be limited to only a single product size. These existing vending machines typically have product stacked in vertical columns of horizontally-oriented product, for example, with one product of a certain type resting upon product of the same type. Moreover, these machines do not work well accommodating with many of the possible shapes and sizes available for vending without extensive changeover modification.

Newer types of vending machines can provide more product options and easily mix products classes, such as beverages and snacks. However, many older-style machines remain in acceptable working order despite their shortcoming accommodating greater options and product varieties. Therefore, there is a need to convert these older machines to take advantage of their existing structures to deliver a greater number of classes of products having flexibility to accommodate many product sizes and shapes without investing the money required to completely replace the older-style vending machines.

U.S. Pat. No. 5,529,207 shows a style that many existing vending machines use. This type of machine has less flexibility in product class and variety. This existing prior art vending machine uses an adjustable retainer system for adapting to various product sizes, particularly product height (which corresponds to compartment width in the '207 patent). Product is delivered horizontally to the user through a delivery port.

U.S. Pat. No. 4,991,739 shows another prior art vending machine whereby the product is stored in vertical columns of horizontally oriented product and a chain drive dispenser for moving dispensed product to the purchaser through a delivery channel.

### SUMMARY OF THE INVENTION

A method of retrofitting an existing vending machine having products stacked vertically in a horizontal orientation in a number of storage locations and utilizing an electro-mechanical device for dispensing said products horizontally via a delivery channel to a delivery port, comprising:
a) replacing said number of selectable storage locations having vertically stacked and horizontally oriented product with a plurality of product shelves each having a plurality of product storage locations having horizontal columns of vertically stored products;
b) replacing said existing electromechanical device for dispensing said vertically stacked and horizontally oriented product with a product dispensing system that retrieves product from the horizontal columns of vertically oriented product in response to a customer selection; and,
c) providing a channel that will convert the vertically oriented product delivered by the dispensing system that converts the vertically oriented product to a horizontally oriented position for delivery through a horizontally oriented customer product delivery port.

### BRIEF DESCRIPTION OF THE DRAWINGS

FIG. 1A shows a typical vending machine of the prior art;

FIG. 1B shows the retrofit kit assembly which fits within the vending machine of FIG. 1A according to an embodiment of the present invention;

FIG. 2 is a top view of the product storage area of the vending machine shown in FIG. 1A;

FIG. 3 is a front view of the storage area showing the delivery channel to move the product to the delivery port for the vending machine shown in FIG. 1A;

FIG. 4 shows a sectional view of the product storage area of FIG. 1A;

FIG. 5 is a top view showing a portion of the storage and delivery shown in FIG. 2;

FIG. 6 is perspective view of the vend delivery mechanism of FIG. 1A;

FIG. 7 is a perspective view of a portion of a product shelf according to an embodiment of the present invention;

FIG. 8 is a top view of a product shelf according to an embodiment of the present invention;

FIG. 9 is a perspective view of a product shelf and delivery cup according to an embodiment of the present invention;

FIG. 10 is a side view and top view of a product delivery channel according to an embodiment of the present invention; and

FIG. 11 is a perspective of a vending machine showing the refrigeration compartment.

### DETAILED DESCRIPTION OF THE PREFERRED EMBODIMENT

While this invention is susceptible of embodiment in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

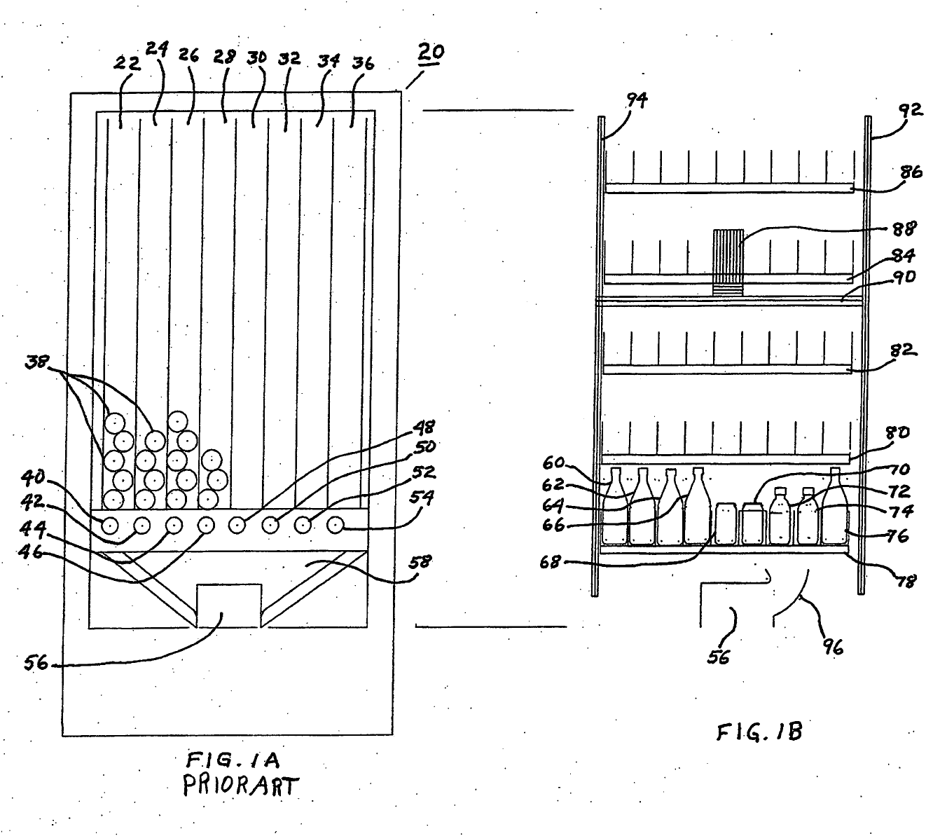

Referring to FIG. 1A, there is shown a front view of a typical beverage vending machine 20 with its storage locations 22 through 36 for stacking products 38 in vertical columns of horizontally-oriented product, with one product of a particular type resting upon another of the same type and with columns of product of different types spaced horizontally from one another. Upon customer selection, the vending machine ejects a lowermost product of the column through the actuation of a corresponding actuator 40 through 54. Upon removal from the column by one of the actuators 40-54, the product falls upon the channel chute 58 and is channeled to the customer delivery port 56 in the horizontally oriented position.

FIG. 1B is a simplified drawing showing the front view of a prior art vending machine cabinet, having been retrofitted according to the present invention. The vending machine comprises a plurality of horizontal columns of vertically oriented product 60 through 76 in its selectable storage area, which accommodates a certain number of like products just behind products 60 through 76. In like arrangement, each of the products 60 through 76 are in selectable storage locations that accommodate product of various sizes and shapes locates on a plurality of shelves 78 through 86. As such, the product 60 is arranged in horizontal columns spaced apart from one another, with each column containing a like product.

In the same configuration, shelves 78 through 86 provide a plurality of storage locations that may be selected by the customer. A product delivery and transport cup (or elevator) 88 removes the product 60 through 76 from the appropriate storage location by means of a robotic system that utilizes tracks 90, 92 and 94 to move the product delivery and transport cup 88 to the appropriate location. The product delivery and transport cup 88 transports the removed product from the selected storage location to direct the product to the delivery port 56 via a channel 96, which provides the transitioning of the vertically transported product to the customer delivery port 56. In order to properly dispense the vertically stored and transported product through the prior art delivery 56, the channel 96 converts the product 60 through 76 to a horizontally oriented configuration.

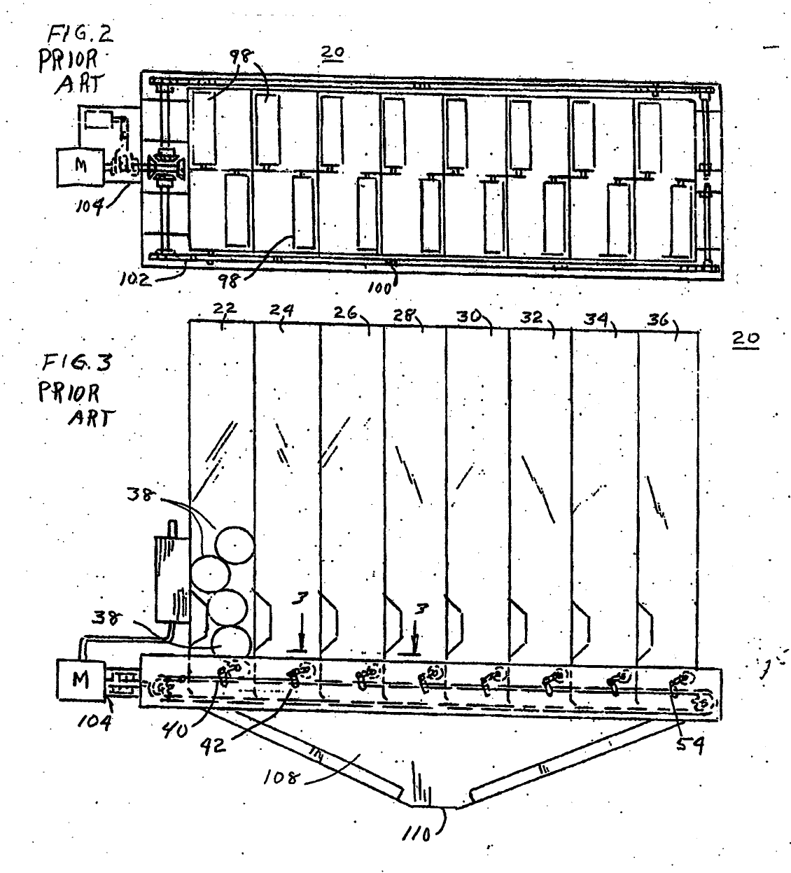

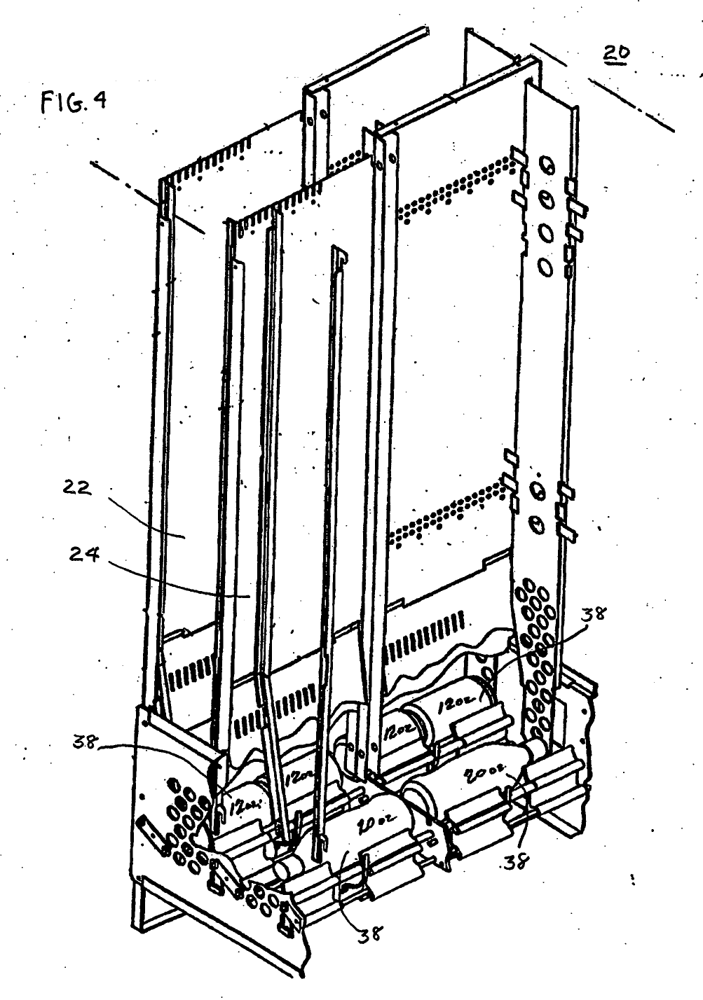

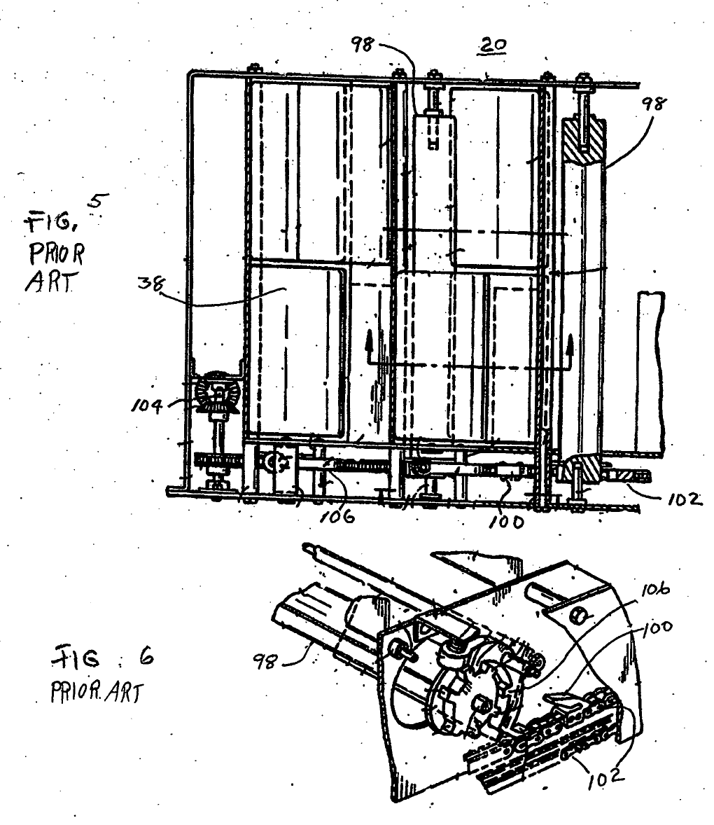

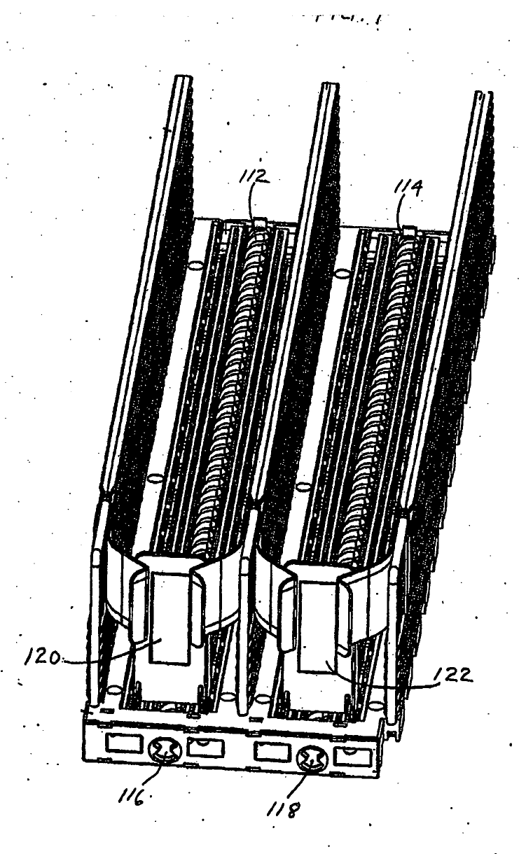

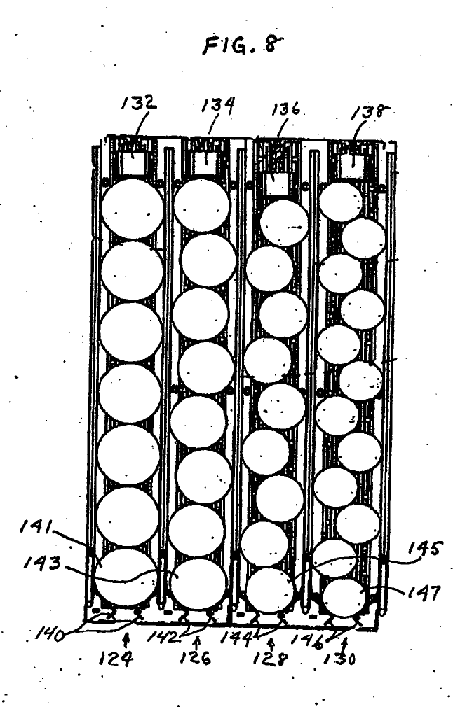

FIG. 2 and FIG. 5 show the existing vending machine 20 of FIG. 1A. Products 38 are delivered to the user by delivery pivots 98, which deliver product from the bottom of each of the columns. The pivots 98 are activated by a finger 100 on a chain 102, which is positioned by a drive system 104. FIG. 6 shows the pivot 98, with its releasing device 106 being activated by the finger 100 attached to the chain 102. The representative system of FIGS. 1A and 3-6 operates in accordance with U.S. Pat. No. 4,991,739, the contents of which are incorporated by reference.

The delivery channel 108 of a typical vendor 20 is shown in FIG. 3 positioned below the storage locations 22 through 36 of FIG. 1A and the actuators 40 through 54 driven by motor drive system 104. The released products 38 are dropped on the delivery channel are directed through the opening 110 to a customer delivery port 56 of FIG. 1A.

Referring to FIG. 7 there is shown a preferred embodiment of the present invention. The preferred embodiment shows an auger driven product removal mechanism. In FIG. 7, only two product locations are shown. However, one of ordinary skill in the art would recognize that any number of product locations can be utilized without departing from the scope of the present invention. The augers 112 and 114 are rotated at the drive engagement points 116 and 118 and move the product forward by the push plates 120 and 122 attached to the augers. As shown, the push plates 120 and 122 are in their most advanced position after the last product has been removed. A detailed description of the auger mechanism is in U.S. Provisional Patent Application Nos. 60/777,160 and 60/701,269, the contents of which are incorporated herein by reference, and U.S. patent application Ser. No. 11/421,935, the contents of which are incorporated herein by reference.

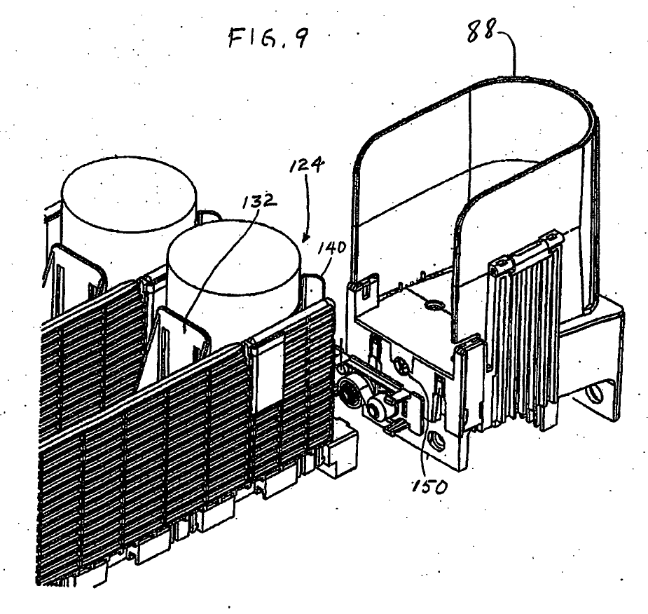

FIG. 8 is a top view of four auger driven product locations 124, 126, 128 and 130. The push plates 132 through 138 are shown in their furthermost rear position when product locations are full. When an auger, such as auger 112 and 114, is driven, its associated push plate 132 through 138 drives product 141, 143, 145, 147 forward to eject one product through the spring release levers 140, 142, 144 and 146. Products 141, 143, 145 and 147 which are driven by respective push plates 132, 134, 136 and 138 are shown with different dimensions than are accommodated by the design of this embodiment. Notice that the number of products in product location 124 is different than the number in each of the other locations 126, 128 and 130 because of the different sized products. The retrofit kit shelf depths will vary according to the vending machine to be retrofitted.

FIG. 9 shows the shelf of FIG. 7 with the product delivery and transport cup 88. The product delivery and transport cup 88 is positioned in the front of the selected product location 124 to engage the augers 112, 114 by the driver 150 operated by a motor therein. Upon the rotation of the auger 112 or 114 by the driver 150, the pusher 132 advances a product through the spring release levers 140 into the delivery cup 88. The spring release lever 140 is used to retain, and then to advance the product properly.

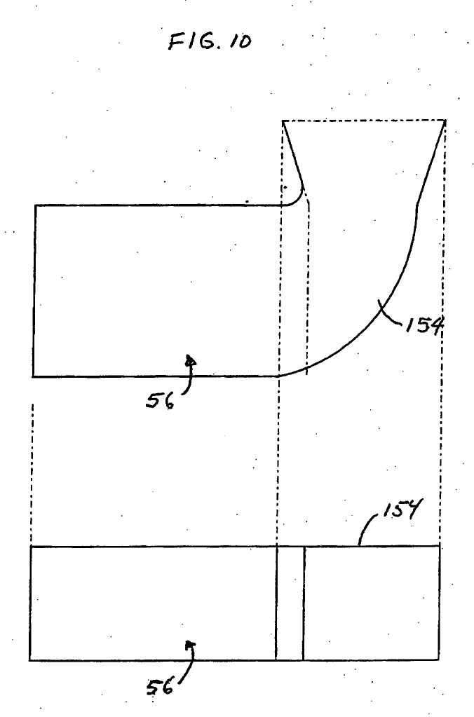

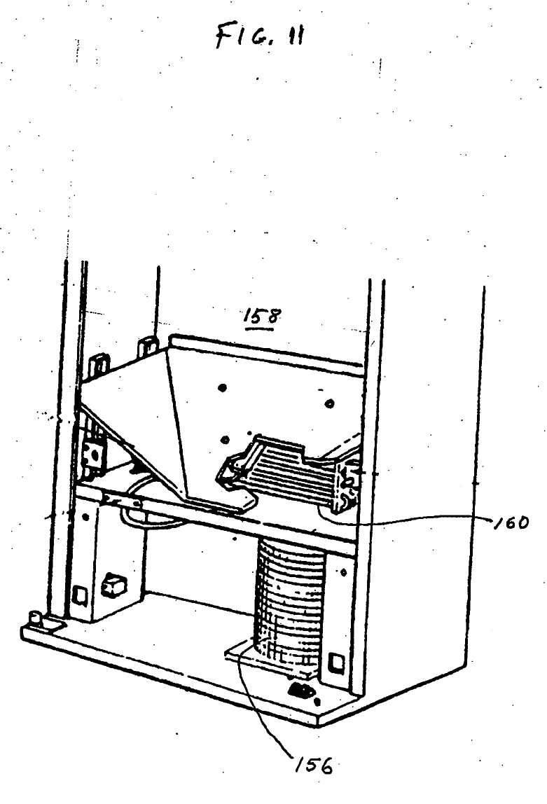

FIGS. 10 and 11 shows the channel 96 for receiving upright product and converting the upright product to a horizontal position to customer presentation through the delivery port 56 of the prior art beverage vending machine 20. In other words, the upright stored product 60-76 of FIG. 1B is delivered by the product delivery and transport cup 88 to the channel 96 whereby the product is rotated 90 degrees such that it can be delivered to the customer horizontally through the delivery port 56.

As shown in FIG. 11, the refrigeration system in the typical prior art vending machine of FIG. 1A has its cooling coils 156 in a zone close to the products to be delivered, near the bottom of the vendor so that the lower products are substantially cooler than the higher products in the stack. Looking now at FIG. 11 and a perspective view of a typical vending machine cooling system with compressor and condenser coil 156 located outside of a cooling compartment 158 with an evaporator coil 160 located within the lower-most portion of the cooling compartment 158. The retrofit kit can provide a moving flow of cool air across the entire storage locations favoring the front delivery area because the shelves 80-86 do not extend to the front of the unit due the volume necessary for movement of the product delivery and transport cup 88. Depending on the particular vending machine being retrofitted, adequate ductwork and coil configurations will be provided to channel sufficient cooling air to all product locations. In this way, uniform cooling will be provided for upper shelves as well as lower shelves.

As such, it can be seen that the vertical columns of horizontally-oriented product as in FIG. 1A are replaced by shelves having horizontal columns of vertically-oriented product as in FIG. 1B. The vertically-oriented product is retrieved by the product delivery and transport cup 88 and delivered to the channel 96, which converts the product to a horizontal position for delivery through the prior art vending machine's delivery port 56.

The above examples show that the invention, as defined by the claims, has far ranging application and should not be limited merely to the embodiments shown and described in detail. Instead, the invention should be limited only to the explicit words of the claims, and the claims should not be arbitrarily limited to embodiments shown in the specification. The scope of protection is only limited by the scope of the accompanying claims, and the Examiner should examine the claims on that basis.

What is claimed is:

1. A method of retrofitting an existing vending machine having products stacked vertically in a horizontal orientation in a number of storage locations and utilizing an electro-mechanical device for dispensing said products horizontally via a delivery channel to a delivery port, comprising:
a) replacing said number of selectable storage locations having vertically stacked and horizontally oriented product with a plurality of product shelves each having a plurality of product storage locations having horizontal columns of vertically stored products;
b) replacing said existing electromechanical device for dispensing said vertically stacked and horizontally oriented product with a product dispensing system that retrieves product from the shelves having horizontal columns of vertically oriented product in response to a customer selection; and,
c) providing a channel that will convert the vertically oriented product delivered by the dispensing system that converts the vertically oriented product to a horizontally oriented position for delivery through a horizontally oriented customer product delivery port.

2. The method of claim 1 wherein the product shelves comprise a plurality of product push plates driven by a helical auger mechanism.

3. The method of claim 2 wherein the product dispensing system is a product delivery and transport cup capable of moving vertically and horizontally to retrieve product from the plurality of horizontal columns of vertically oriented product.

4. The method of claim 3 wherein the push plates are driven at a constant velocity to deliver product.

5. The method of claim 4 wherein the shelves are adapted to deliver product of varying sizes through the constant-width product storage channels.

6. The method of claim 5 further comprising a refrigeration system for uniformly cooling of the horizontal columns of vertically oriented products.

7. The method of claim 1 further comprising the step of providing uniform product cooling from the upper shelves to the lower shelves.

8. The method of claim 7 wherein the uniform cooling is accomplished via adequate ductwork.

9. A method of retrofitting an existing vending machine having products stacked vertically in a horizontal orientation in a number of storage locations and utilizing an electro-mechanical device for dispensing said products horizontally via a delivery channel to a delivery port, comprising:
a) replacing said number of selectable storage locations having vertically stacked and horizontally oriented product with a plurality of product shelves each having a plurality of product storage locations having horizontal columns of vertically stored products;
b) replacing said existing electromechanical device for dispensing said vertically stacked and horizontally oriented product with a product dispensing system capable of moving vertically to retrieve product from the shelves having horizontal columns of vertically-oriented product in response to a customer selection; and,
c) providing a channel that will convert the vertically oriented product delivered by the dispensing system that converts the vertically oriented product to a horizontally oriented position for delivery through a horizontally oriented customer product delivery port.

10. The method of claim 9 wherein the product shelves comprise a plurality of product push plates driven by a helical auger mechanism.

11. The method of claim 10 wherein the product delivery system is a product delivery and transport cup capable of moving vertically and horizontally to retrieve product from the plurality of horizontal columns of vertically oriented product.

12. The method of claim 11 wherein the push plates are driven at a constant velocity to deliver product.

13. The method of claim 12 wherein the shelves are adapted to deliver product of varying sizes through the constant-width product storage channels.

14. The method of claim 13 further comprising a refrigeration system for uniformly cooling of the horizontal columns of vertically oriented products.

15. The method of claim 9 further comprising the step of providing uniform product cooling from the upper shelves to the lower shelves.

16. The method of claim 15 wherein the uniform cooling is accomplished via adequate ductwork.

17. A method of retrofitting an existing vending machine having products stacked vertically in a horizontal orientation in a number of storage locations and utilizing an electro-mechanical device for dispensing said products horizontally via a delivery channel to a delivery port, comprising:
a) replacing said number of selectable storage locations having vertically stacked and horizontally oriented product with a plurality of product shelves each having a plurality of product storage locations having horizontal columns of vertically stored products, the shelves comprising a plurality of product push plates;
b) replacing said existing electromechanical device for dispensing said vertically stacked and horizontally oriented product with a product dispensing system capable of moving vertically to retrieve product from the shelves having horizontal columns of vertically-oriented product in response to a customer selection; and,
c) providing a channel that will convert the vertically oriented product delivered by the dispensing system that converts the vertically oriented product to a horizontally oriented position for delivery through a horizontally oriented customer product delivery port.

18. The method of claim 17 wherein the plurality of product push plates are driven by a helical auger mechanism.

19. The method of claim 18 wherein the product delivery system is a product delivery and transport cup capable of moving vertically and horizontally to retrieve product from the plurality of horizontal columns of vertically oriented product.

20. The method of claim 19 wherein the push plates are driven at a constant velocity to deliver product.

21. The method of claim 20 wherein the shelves are adapted to deliver product of varying sizes through the constant-width product storage channels.

22. The method of claim 21 further comprising a refrigeration system for uniformly cooling of the horizontal columns of vertically oriented products.

23. The method of claim 17 further comprising the step of providing uniform product cooling from the upper shelves to the lower shelves.

24. The method of claim 23 wherein the uniform cooling is accomplished via adequate ductwork.
